(19) United States
(12) Patent Application Publication
(10) Pub. No.: US 2018/0246341 A1
(43) Pub. Date: Aug. 30, 2018

(54) OIS CAMERA MODULE FAVORABLE TO DUAL CAMERA ARRANGEMENT AND DUAL CAMERA SYSTEM INCLUDING THE OIS CAMERA MODULES

(71) Applicant: MDpulse Co.,Ltd., Gyeongsangbuk-do (KR)

(72) Inventors: Tae-Hoon JUNG, Gyeonggi-do (KR); Jin-Suk HAN, Incheon (KR)

(21) Appl. No.: 15/610,344

(22) Filed: May 31, 2017

(30) Foreign Application Priority Data
Feb. 27, 2017 (KR) 10-2017-0025446

(51) Int. Cl. G02B 27/64; G03B 13/36; G02B 7/09; H02K 41/035

(52) U.S. Cl. CPC G02B 27/646; H02K 41/0356; G02B 7/09; G03B 13/36

(57) ABSTRACT

Disclosed is an OIS camera module including: a module base; a lens carrier movably mounted on the module base; and at least one OIS actuator controlling movement of the lens carrier in a horizontal direction vertical to an optical axis of the lens carrier, and each OIS actuator includes a coil and a magnet unit, and a main magnetic flux line direction of the magnet unit is aligned parallel to the optical axis.

### CROSS-REFERENCE TO RELATED APPLICATIONS

This application claims priority to and the benefit of Korean Patent Application No. 10-2017-025446 filed in the Korean Intellectual Property Office on Feb. 27, 2017, the entire contents of which are incorporated herein by reference.

### TECHNICAL FIELD

The present invention relates to a camera module having a hand-shake correction function, and more particularly, to an OIS camera module favorable to dual camera arrangement and a dual camera system.

### BACKGROUND ART

A camera module having an auto focusing (AF) function to automatically control a focus of a lens at the time of photographing a subject is generally applied to a general digital camera and a mobile device such as a cellular phone or a tablet PC.

In recent years, the function of the camera module is not limited to the auto focusing (AF) function and the camera module adopts a hand-shake prevention function. A hand-shake prevention scheme may be classified into an electronic scheme and an optical scheme. An electronic correction scheme (electronic image stabilizer (EIS) is a scheme that corrects and processes an image signal output from an image sensor with a program. On the contrary, an optical hand-shake correction scheme (optical image stabilizer (OIS) is a scheme that mechanically controls a position or an angle of the image sensor or a lens optical system.

Since a structure of a camera module with an OIS device is complicated and a volume of the camera module is large, there a lot of difficulties in adopting the camera module for the mobile device. For example, Korean Patent Unexamined Publication No. 10-2007-0065195 discloses a device for image incline correction and the device may not structurally be applied to the mobile device such as the smart phone.

However, as the OIS device is enabled to be miniaturized, a camera module which includes the OIS function and is small is developed like Korean Patent Unexamined Publication No. 10-2011-0097122. However, four magnets are mounted on four planes of the camera module for the AF and OIS functions.

Since a magnetic field is widely formed around the small camera module, the small camera module may influence an external device. In particular, in developing the mobile device with a dual camera, there is a limit that two camera modules need to be spaced apart from each other by a predetermined distance.

### SUMMARY OF THE INVENTION

The present invention has been made in an effort to provide an OIS camera module capable of maximally reducing an external influence due to a magnetic field.

The present invention has also been made in an effort to provide an OIS camera module favorable to dual camera arrangement by maximally reducing a mutual influence due to the magnetic field.

The present invention has been made in an effort to provide an OIS camera module capable of reducing the number of modules for an AF function and the number of modules for an OIS function and safely disposing loads in balance.

An exemplary embodiment of the present invention provides an OIS camera module including: a module base; a lens carrier movably mounted on the module base; and at least one OIS actuator controlling movement of the lens carrier in a horizontal direction vertical to an optical axis of the lens carrier, and each OIS actuator includes a coil and a magnet unit, and a main magnetic flux line direction of the magnet unit is aligned parallel to the optical axis.

Herein, the main magnetic flux line direction may mean a direction parallel to a straight line linking the centers of N and S poles of a magnet. In the OIS camera module in the related art, a main magnetic flux line of the magnet of the OIS actuator is formed in a horizontal direction, that is, a direction vertical to the optical axis and radially disposed in four directions in the OIS camera module. Therefore, in the OIS camera module in the related art, a magnetic field by the magnet of the OIS actuator may influence other components in the vicinity thereof and even in a dual camera configuration with a magnetic body, the camera modules are impossible to be close to each other by approximately 5 mm or less.

However, in the present invention, since the main magnetic flux line direction of the magnet of the OIS actuator is parallel to the optical axis, the influence of which the magnetic field by the magnet of the OIS exerts to neighboring components is slight and when the magnet is grafted to a dual camera system, two camera modules may be disposed to be close to each other by 3 mm or less.

In detail, since in the magnet unit, the direction of the main magnetic flux line is formed parallel to the optical axis, two or more magnets may be required. To this end, the magnet unit may include a first magnet and a second magnet in which the main magnetic flux line is aligned in a vertical direction and the first and second magnets are disposed adjacent to each other and pole directions of the magnetic fields may be disposed to be opposite to each other.

Differently, the magnet unit may include the first magnet and a third magnet in which the main magnetic flux line is aligned vertically, the first magnet and the third magnet may be disposed adjacent to each other in a vertical direction, that is, disposed to correspond to each other up and down with a coil interposed therebetween, and the pole directions of the magnetic fields may be disposed to be the same as each other.

Besides, the magnet unit may include the first magnet, the second magnet, the third magnet, and a fourth magnet in which the main magnetic flux line direction is parallel to the optical axis to correspond to one coil. Herein, as described above, the first magnet and the second magnet are disposed adjacent to each other in the horizontal direction below the coil and the pole directions of the magnetic fields are opposite to each other and the third magnet and the fourth magnet which are two residual magnets may be provided to correspond to the first and second magnets above the coil. Therefore, in the case where the third and fourth magnets are used, force may be applied, which is almost twice larger than a case where only the first and second magnets are used in one coil. The first magnet and the third magnet may be disposed to correspond to the same position in plane while the pole direction of the magnetic fields are disposed to be the same as each other up and down based on the coil in order to strengthen force of magnet sets disposed up and down and the second magnet and the fourth magnet may also be disposed to correspond to each other at the same position in plane.

When the magnet sets are disposed up and down, the number of OIS actuators may be reduced to approximately ½. That is, as compared with a case where four OIS actuators are used in the related art, when the OIS actuators are disposed up and down, two OIS actuators may be used and since the coil is shared, the size of the OIS actuator may also be formed to be small. Further, since a sufficient thrust may be formed even though only two OIS actuators are used, the camera module may be designed to be smaller and the AF actuator and the OIS actuator are disposed to be opposite to each other to more easily control the balance of the lens carrier in overall.

The OIS camera module according to the present invention may further include an AF actuator which moves a lens of the lens carrier in the direction of the optical axis apart from the OS actuator and as described above, since the number of OIS actuators may be reduced to approximately ½, the OIS actuator and the AF actuator may be designed to be disposed at opposite sides to each other based on the lens carrier.

Herein, the AF actuator may also include a separate coil and a separate magnet and the magnetic flux line direction of the magnet of the AF actuator may be formed parallel to the optical axis and vertically to the optical axis.

The OIS camera module may include a first OIS actuator and a second OIS actuator as the OIS actuator, the first OIS actuator may be disposed while forming an angle of 110 to 145 degrees with respect to the AF actuator, and the second OIS actuator may be disposed while forming an angle of 210 to 250 degrees with respect to the AF actuator.

According to an exemplary embodiment of the present invention, a dual camera system which may be applied to a portable terminal may be provided by using two OIS camera modules and each OIS camera module may include: a module base; a lens carrier movably mounted on the module base; and at least one OIS actuator controlling movement of the lens carrier in a horizontal direction vertical to an optical axis of the lens carrier. Herein, a first OIS camera module and a second OIS camera module may be provided at an interval of about 0˜3 mm, in the first OIS camera module and the second OIS camera module, each OIS actuator may include a coil and a magnet unit, and all main magnetic flux line directions of the magnet unit included in the OIS actuator may be aligned parallel to the optical axis.

According to exemplary embodiments of the present invention, an OIS camera module includes at least one OIS actuator and since the OIS actuator generally controls a 2D motion in plane, there are a lot of cases in which two or more OIS actuators are provided. Therefore, when a main magnetic flux line direction of a magnet used for the OIS actuator is vertically disposed, an external influence due to a magnetic field can be maximally reduced.

Since the OIS camera module can maximally reduce a mutual influence due to the magnetic field, even though it is assumed that two OIS camera modules are used, it is very favorable in disposing both camera modules close to each other.

In particular, as described above, when magnet sets having mutually opposite pole directions are vertically disposed with one coil interposed therebetween, one OIS actuator can substitute for two existing OIS actuators and the number of OIS actuators can be reduced to approximately a half while maintaining the same OIS function as the related art.

Consequently, being capable of reducing the number of OIS actuators means being capable of reducing the size of the camera module more compactly and being capable of using two OIS actuators means being capable of distributing a load of a lens carrier in balance around an optical axis by appropriately disposing an AF actuator and an OIS actuator. Further, both the OIS actuators and the AF actuators are positioned as wide as possible to minimize mutual magnetic interference.

### BRIEF DESCRIPTION OF THE DRAWINGS

FIG. 1 is an exploded perspective view for describing a structure of an OIS camera module according to an exemplary embodiment of the present invention.

FIG. 2 is a cross-sectional view of the OIS camera module of FIG. 1.

FIG. 3 is a partially enlarged diagram for describing an operation of an OIS actuator of FIG. 2.

FIG. 4 is a cross-sectional view for describing the structure of the OIS camera module according to the exemplary embodiment of the present invention.

FIG. 5 is a partially enlarged diagram for describing the operation of the OIS actuator of FIG. 4.

FIG. 6 is a plan view for describing the structure of the OIS camera module according to the exemplary embodiment of the present invention.

FIG. 7 is a perspective view for describing a direction of a main magnetic flux line by a magnet in the OIS camera module of FIG. 6.

FIG. 8 is a plan view for describing examples of constituting a dual camera system by using an OIS camera module according to an exemplary embodiment of the present invention.

### DETAILED DESCRIPTION

Hereinafter, exemplary embodiments of the present invention will be described in detail with reference to the accompanying drawings, but the present invention is not limited or restricted to the exemplary embodiments. For reference, in the description, like reference numerals substantially refer to like elements, which may be described by citing contents disclosed in other drawings under such a rule and contents determined to be apparent to those skilled in the art or repeated may be omitted.

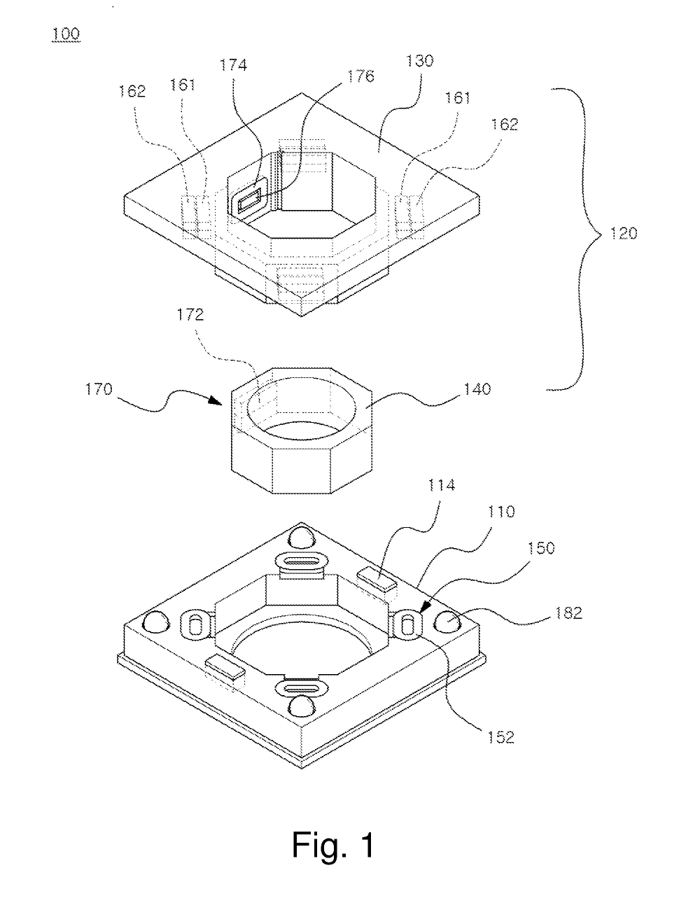

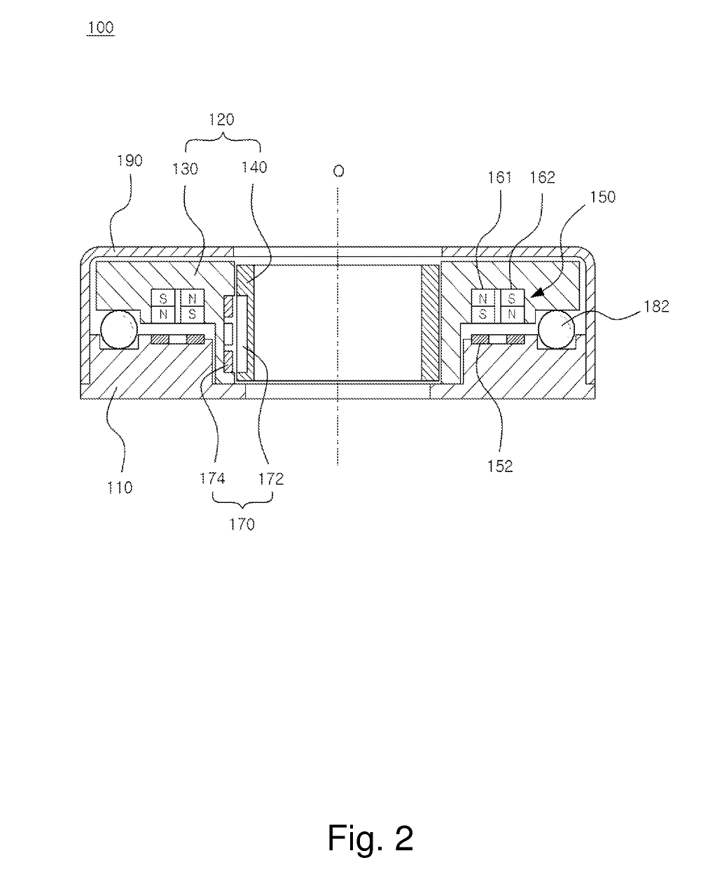

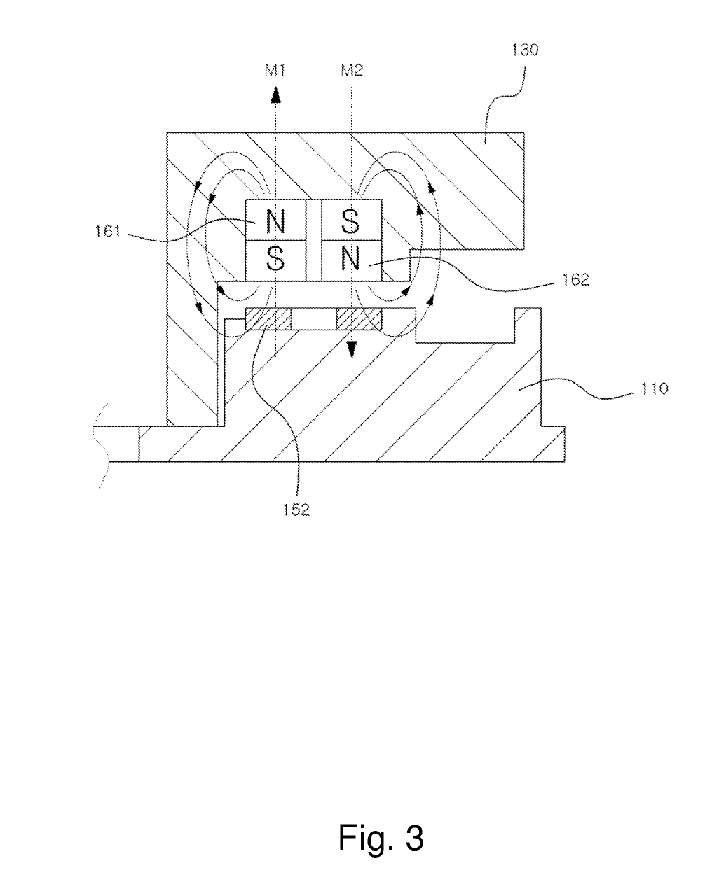

FIG. 1 is an exploded perspective view for describing a structure of an OIS camera module according to an exemplary embodiment of the present invention, FIG. 2 is a cross-sectional view of the OIS camera module of FIG. 1, and FIG. 3 is a partially enlarged diagram for describing an operation of an OIS actuator of FIG. 2.

Referring to FIGS. 1 to 3, an OIS camera module 100 according to the exemplary embodiment includes a module base 110, a lens carrier 120, four OIS actuators 150, and one AF actuator 170. As illustrated in FIG. 2, a cover 190 having a hole formed at the center thereof may be further mounted while the module base 110, the lens carrier 120, etc., are joined.

In the exemplary embodiment, an ‘optical axis’ may be appreciated as a line for linking the center of a lens and the center of an image sensor and appreciated as a vertical line passing through the center based on the module base 110. Therefore, an ‘optical axis direction’ may be appreciated as a direction which coincides with the optical axis or be parallel or substantially horizontal to the optical axis. As a result, a ‘horizontal direction’ may be appreciated as a direction vertical to the optical axis or almost vertical to the optical axis. As one example, when a coordinate system constituting x, y, and z axes is assumed, if the z axis is the optical axis, a direction in which only (x, y) is expressed as well as the x and y axes may be referred to as the horizontal direction.

The lens carrier 120 includes a lens cylinder 140 and a carrier body 130 on which a lens (not illustrated) is mounted. The AF actuator 170 is mounted between the lens cylinder 140 and the carrier body 130 and the OIS actuators 150 are mounted on respective corners between the carrier body 130 and the module base 110 in the vicinity of the lens cylinder 140.

In detail, the AF actuator 170 includes an AF magnet 172 mounted on an outer surface of the lens cylinder 140 and an AF coil 174 and a hall sensor 176 mounted on an inner surface of the carrier body 130 to face the AF magnet 172. The lens cylinder 140 may move vertically to the carrier body 130 according to an intensity and a direction of current supplied to the AF coil 174 and the lens of the lens cylinder 140 may focus on an image sensor (not illustrated) while moving vertically. Although not separately illustrated in FIG. 2, a support unit using a ball or a protrusion may be further provided to maintain an interval between the lens cylinder 140 and the carrier body 130.

Further, the OIS actuators 150 are provided to four corners of the OIS camera module 100 and the respective OIS actuators 150 may perform correction by hand-shake of a user while moving the lens carrier 120 in a diagonal direction. The OIS actuator 150 also includes an OIS coil 152, a first OIS magnet 161, and a second OIS magnet 162 for electrically controlling a position.

In the exemplary embodiment, the first OIS magnet 161 and the second OIS magnet 162 form one magnet unit and directions of main magnetic flux lines M1 and M2 are aligned to a direction parallel to the optical axis O. The first OIS magnet 161 and the second OIS magnet 162 are disposed adjacent to a control direction of the OIS actuator 150, that is, the diagonal direction and N and S poles are arranged up and down or vertically unlike the related art. In more detail, in the first OIS magnet 161, the N pole and the S pole are aligned to face up and down, respectively, while in the second OIS magnet 162, the S pole and the N pole are aligned to face up and down, respectively. Therefore, force may be applied in the same direction along the direction of the current which flows on the OIS foil 152.

The control unit controls four OIS actuators 150 to 2D-control a horizontal position of the lens carrier 120 to the module base 110. Four OIS actuators 150 may be individually controlled, but the OIS actuators 150 positioned on the diagonal line to each other are together controlled to control a 2D position of the lens carrier 120.

In order to maintain a horizontal height of the lens carrier 120 to the module base 110, ball pockets and balls 182 may be provided at four corners of the module base 110 and a suction magnet 114 mounted on the module base 110 and a suction yoke mounted on the bottom of the lens carrier 120 may be further provided between the respective balls 182. The suction magnet 114 and the suction yoke may prevent the lens carrier 120 from being separated from the module base 110 and maintain the lens carrier 120 to be closely attached to the module base 110 and the ball 182 accommodated in the ball pocket may support the lens carrier 120 so that the lens carrier 120 horizontally moves without friction. Besides, a spring for restoration to an original position in plane, etc., may be further provided.

The module base 110 may have the hole at a lower portion of the center to correspond to the lens cylinder 140 and the image sensor, etc., are positioned in the hole to acquire an image by auto focusing and hand-shake prevention of the OIS camera module 100.

Referring to FIG. 3, the pole directions of the first and second OIS magnets 161 and 162 are opposite to each other and the carrier body 130 may move in the direction vertical to the optical axis O to correspond to the OIS coil 152. A magnetic field is formed even in the vicinity of the first and second OIS magnets 161 and 162, but a center line linking the N and S poles, that is, the main magnetic flux lines M1 and M2 are disposed parallel to the optical axis. Therefore, the magnetic field may be formed with high density in the direction of the main magnetic flux line and reduce an influence applied to the outside with low density in the vicinity thereof.

In the exemplary embodiment, in the OIS actuator 150, the OIS coil 152 is mounted on the module base 110 and the first and second OIS magnets 161 and 162 are mounted on the lens carrier 120, but in another exemplary embodiment of the present invention, the positions of the OIS coil and the OIS magnet may be changed to each other. The possibility may be similarly applied even to the positions of the coil and the magnet of the AF actuator 170.

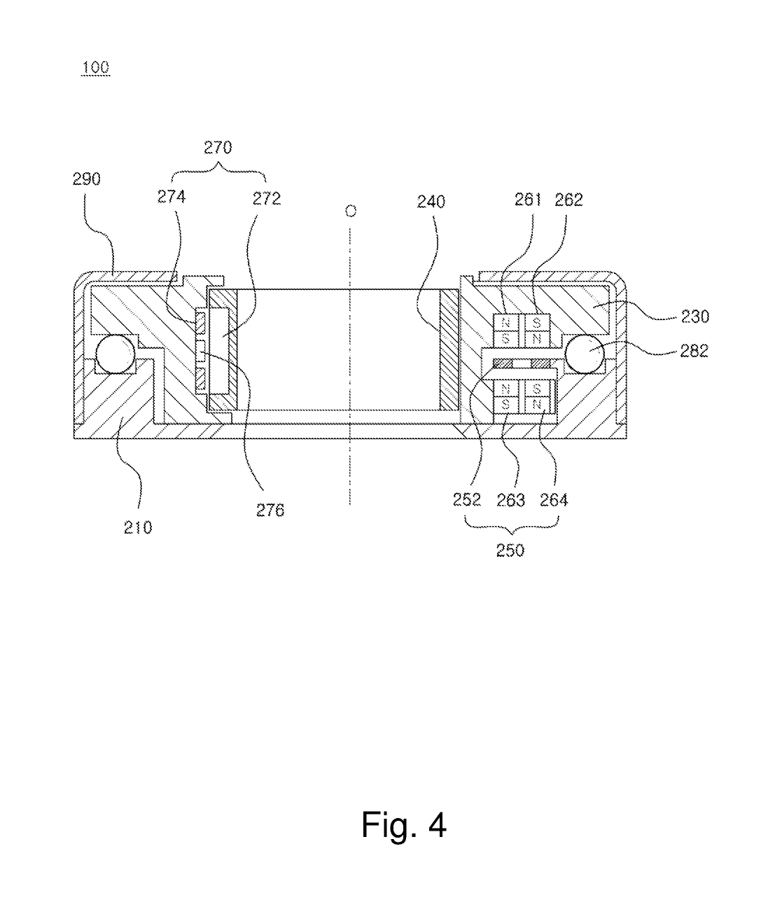

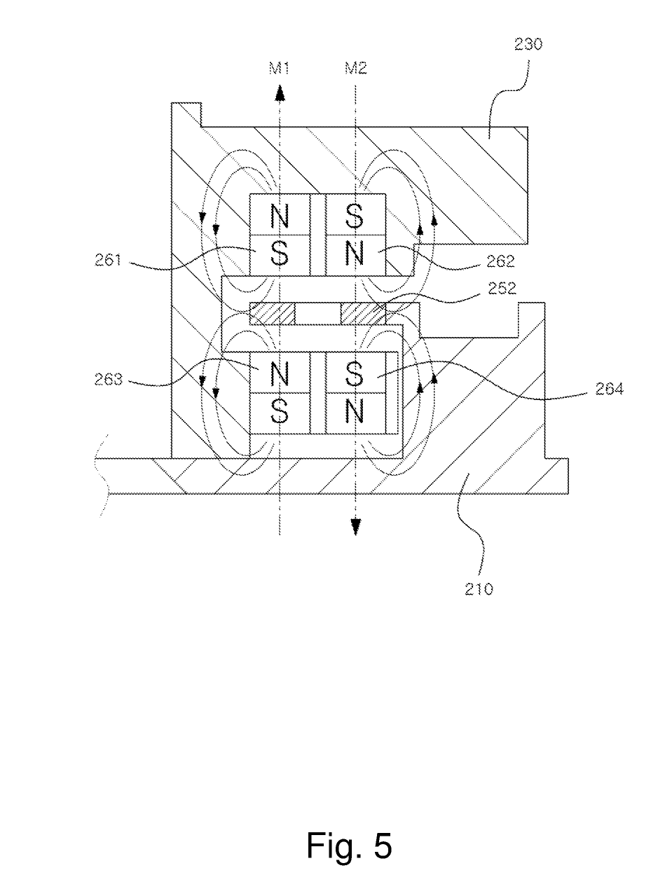

FIG. 4 is a cross-sectional view for describing the structure of the OIS camera module according to the exemplary embodiment of the present invention and FIG. 5 is a partially enlarged diagram for describing the operation of the OIS actuator of FIG. 4.

Referring to FIGS. 4 to 5, an OIS camera module 200 according to the exemplary embodiment includes a module base 210, a lens carrier including a carrier body 230 and a lens cylinder 240, an OIS actuator 250, and an AF actuator 270. Further, a cover 290 having the hole formed at the center thereof may be further mounted while the module base 210, the lens carrier, etc., are joined.

As described above, the lens carrier includes the lens cylinder 240 and the carrier body 230 on which a lens (not illustrated) is mounted. The AF actuator 270 may be mounted between the lens cylinder 240 and the carrier body 230 and the OIS actuators 250 may be mounted between the carrier body 230 and the module base 110 in the vicinity of the lens cylinder 240.

In detail, the AF actuator 270 may include an AF magnet 272 mounted on the outer surface of the lens cylinder 240 and an AF 274 and a hall sensor 276 mounted on the inner surface of the carrier body 230 to face the AF magnet 272.

In the exemplary embodiment, the OIS actuator 250 includes four magnets, that is, a first OIS magnet 261, a second OIS magnet 262, a third OIS magnet 263, and a fourth OIS magnet 264. As illustrated in FIGS. 4 and 5, the first OIS magnet 261 and the second OIS magnet 262 form one magnet unit and are positioned above the OIS coil 252 and the third OIS magnet 263 and the fourth OIS magnet 264 also form another magnet unit and are positioned below the OIS coil 252.

The directions of the main magnetic flux lines M1 and M2 of the first to fourth OIS magnets 261 to 264 are aligned in the direction parallel to the optical axis O. That is, the N pole and the S pole are arranged up and down or vertically unlike the related art. In the first and third OIS magnets 261 and 263, the N pole and the S pole are aligned to face up and down, respectively, while in the second and fourth OIS magnets 262 and 264, the S pole and the N pole are aligned to face up and down, respectively. Therefore, the force may be applied in the same direction along the direction of the current which flows on the OIS foil 252.

Referring to FIG. 5, while the OIS magnets 261 to 264 are disposed up and down, the OIS actuator 250 may provide higher power than the OIS actuator of FIG. 3 and the number of OIS actuators may be reduced to approximately ½ based on the same power. For example, only two OIS actuators 250 may be used while the magnets are disposed up and down with the same function as using four OIS actuators in the related art. Further, since the coil is shared, the size of the OIS actuator may also be formed to be small.

Since the OIS actuator 250 may be used with a half of the existing number, the camera module 200 may be designed to be smaller.

Since the first and third OIS magnets 261 and 263 are disposed up and down while maintaining the same pole direction and the second and fourth OIS magnets 262 and 264 are also opposite to each other, but the second and fourth OIS magnets 262 and 264 are disposed up and down while maintaining the same pole direction, the OIS coil 252 is controlled in the same method as the related art to perform correction by user's hand-shake.

The pole directions of the first and second OIS magnets 261 and 262 may be opposite to each other and the carrier body 230 may move in the direction vertical to the optical axis 0 to correspond to the OIS coil 252. The magnetic field is formed even in the vicinity of the first and second OIS magnets 261 and 262, but the center line linking the N and S poles, that is, the main magnetic flux lines M1 and M2 are disposed parallel to the optical axis. Therefore, the magnetic field may be formed with high density in the direction of the main magnetic flux line and reduce the influence applied to the outside with low density in the vicinity thereof.

In the exemplary embodiment, in the OIS actuator 250, the OIS coil 252 is mounted on the module base 210 and the first to fourth OIS magnets 261 to 264 are mounted on the lens carrier, but in another exemplary embodiment of the present invention, the positions of the OIS coil and the OIS magnet may be changed to each other.

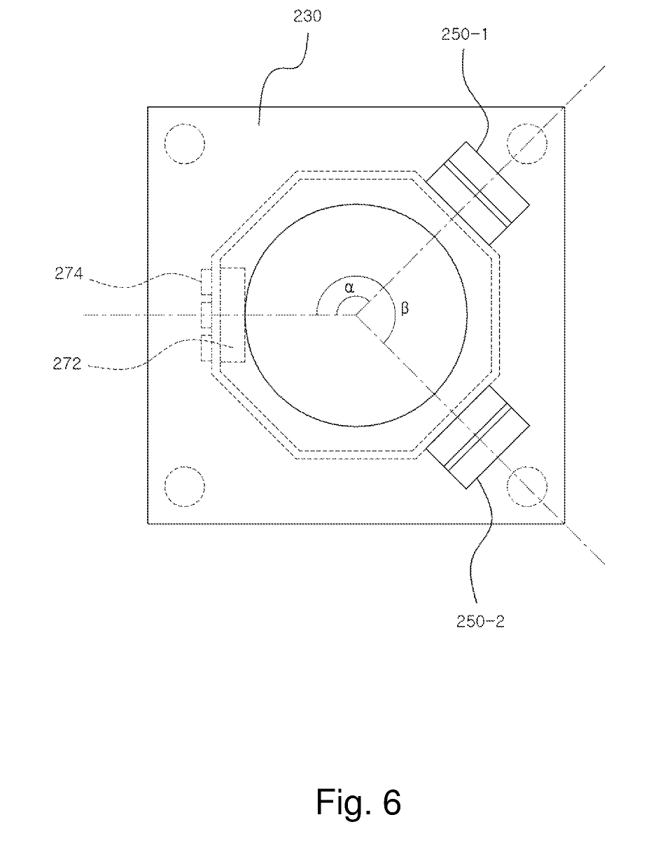

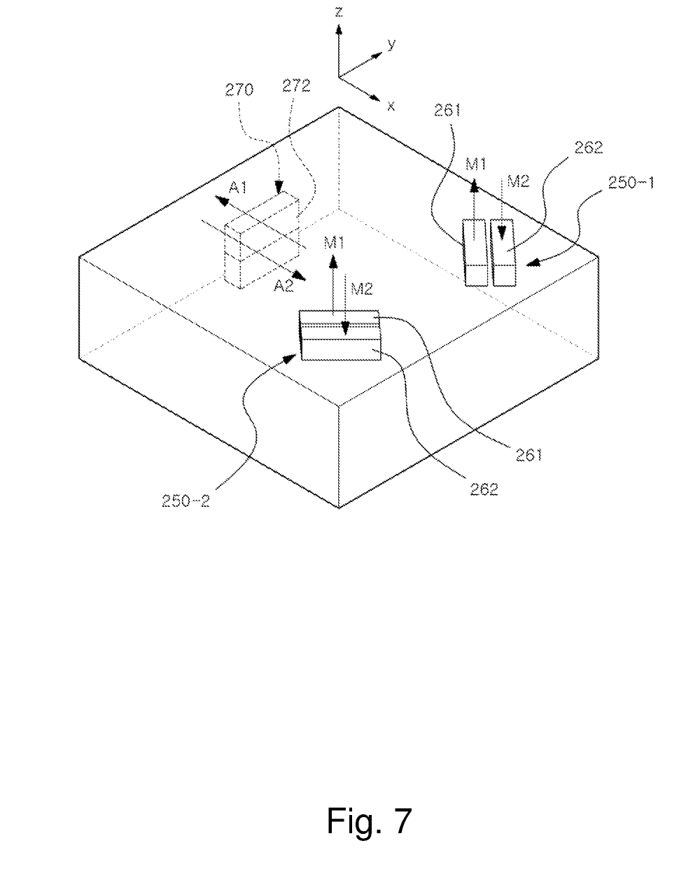

FIG. 6 is a plan view for describing the structure of the OIS camera module according to the exemplary embodiment of the present invention and FIG. 7 is a perspective view for describing a direction of a main magnetic flux line by a magnet in the OIS camera module of FIG. 6.

For reference, in the exemplary embodiment, since the structure of the OIS actuator 250 described in FIGS. 4 and 5 may be used, a detailed structure may describe the previous exemplary embodiment.

Referring to FIGS. 6 and 7, the OIS camera module according to the exemplary embodiment may include one AF actuator 270 and two OIS actuators, that is, a first OIS actuator 250-1 and a second OIS actuator 250-2.

The AF actuator 270 may be disposed between the lens cylinder 240 and the carrier body 230, the first OIS actuator 250-1 may be disposed while forming an angle a of approximately 135 degrees with respect to the AF actuator 270 around the lens carrier 220, and the second OIS actuator 250-2 may be disposed while forming an angle β of approximately 225 degrees. Besides, the first OIS actuator 250-1 may be disposed while forming an angle a of approximately 110 to 145 degrees with respect to the AF actuator 270 and the second OIS actuator 250-2 may be disposed while forming an angle β of approximately 210 to 250 with respect to the AF actuator 270.

Consequently, the first and second OIS actuators 250-1 and 250-2 are provided to two right corners of the OIS camera module and independently operate, respectively to move the lens carrier 220 2-dimensitonally.

As described in FIG. 5, since four OIS magnets 261 to 264 are provided up and down around one OIS coil 252, the lens carrier 220 may perform a sufficient OIS function only by two actuators of the first and second OIS actuators 250-1 and 250-2. Referring to FIG. 6, in general, since the AF actuator 270 is disposed at a left side of the OIS camera module and the first OIS actuator 250-1 and the second OIS actuator 250-2 are provided at a right side, the first and second OIS actuators 250-1 and 250-2 may be balanced horizontally around the lens carrier 220 and the first and second OIS actuators 250-1 and 250-2 are also vertically balanced to generally maintain a balance.

Since the main magnetic flux lines M1 and M2 of the OIS magnets 261 and 262 are formed parallel to the optical axis, the influence of the magnetic field transferred to the vicinity may be reduced. However, a main magnetic flux line A of the AF actuator 270 may be formed in a horizontal direction vertical to the optical axis, but the camera module is appropriately disposed to minimize an influence exerted to another camera.

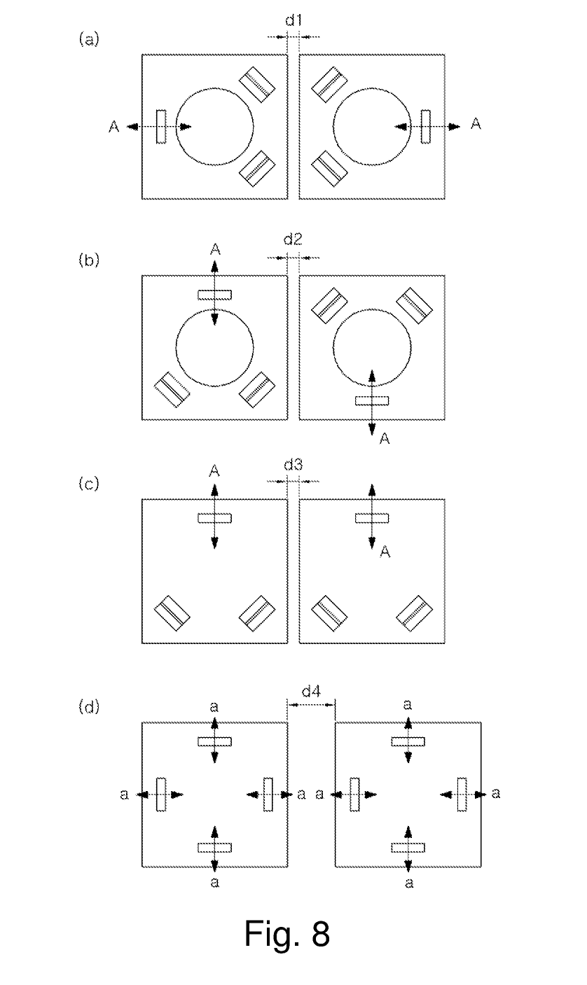

FIG. 8 is a plan view for describing examples of constituting a dual camera system by using an OIS camera module according to an exemplary embodiment of the present invention.

Referring to FIG. 8, various layouts may be achieved by using the camera module illustrated in FIG. 6. For example, as illustrated in FIG. 8A, the OIS camera modules are disposed adjacent to each other and the AF actuators included in the respective OIS camera modules may be mounted to be disposed at opposite positions. In this case, the main magnetic flux line A of the AF actuator is aligned in the horizontal direction, but a distance d1 between the camera modules which are distant from each other may be reduced to 3 mm or less.

Referring to FIG. 8D, in the existing camera module, the AF actuators are mounted on all of four sides of the OIS camera module and even though a main magnetic flux line a is disposed in any direction toward the outside, it is impossible to narrow a distance d4 between the camera modules to 5 mm or less.

However, according to the exemplary embodiment, even though only two OIS actuators are used, sufficient power may be provided and the OIS actuator may be disposed at an opposite side to the AF actuator, and as a result, the dual cameras close to each other may be disposed as illustrated in FIGS. 8A, 8B, and 8C. In particular, since the main magnetic flux line of the OIS actuator is parallel to the optical axis direction, interference by the magnetic may be minimized even though the OIS actuators are arranged to be closely attached to each other. Those skilled in the art to which the present invention belongs may perform various layouts of the dual camera by using layouts of FIGS. 8A, 8B, and 8C and apply the layout to not dual but triple or quadruple layout.

As described above, the present invention has been described with reference to the exemplary embodiments of the present invention. However, it will be appreciated by those skilled in the art that various modifications and changes of the present invention can be made without departing from the spirit and the scope of the present invention which are defined in the appended patent claims.

What is claimed is:

1. An OIS camera module comprising:
a module base;
a lens carrier movably mounted on the module base; and
at least one OIS actuator controlling movement of the lens carrier in a horizontal direction vertical to an optical axis of the lens carrier,
wherein each OIS actuator includes a coil and a magnet unit, and
a main magnetic flux line direction of the magnet unit is aligned parallel to the optical axis.

2. The OIS camera module of claim 1, wherein the magnet unit includes a first magnet and a second magnet in which the main magnetic flux line direction is parallel to the optical axis to correspond to one coil, and
wherein the first magnet and the second magnet are disposed adjacent to each other in the horizontal direction and pole directions of magnetic fields are opposite to each other.

3. The OIS camera module of claim 1, wherein the magnet unit includes the first magnet and a third magnet in which the main magnetic flux line direction is parallel to the optical axis to correspond to one coil, and
wherein the first magnet and the third magnet are disposed to correspond to each other up and down based on the coil and the pole directions of the magnetic fields are the same as each other.

4. The OIS camera module of claim 1, wherein the magnet unit includes the first magnet, the second magnet, the third magnet, and a fourth magnet in which the main magnetic flux line direction is parallel to the optical axis to correspond to one coil,
wherein the first magnet and the second magnet are disposed adjacent to each other in the horizontal direction below the coil and the pole direction of the magnetic fields are opposite to each other,
wherein the third magnet and the fourth magnet are disposed adjacent to each other in the horizontal direction above the coil and the pole directions of the magnetic fields are opposite to each other,
wherein the first magnet and the third magnet are disposed to correspond to each other up and down based on the coil, and
wherein the second magnet and the fourth magnet are disposed to correspond to each other up and down based on the coil.

5. The OIS camera module of claim 1, further comprising:
an AF actuator which moves a lens of the lens carrier in the direction of the optical axis apart from the OS actuator,
wherein the OIS actuator and the AF actuator are disposed at opposite sides to each other based on the lens carrier.

6. The OIS camera module of claim 5, wherein the AF actuator includes a magnet and the main magnetic flux line direction of the magnet of the AF actuator is vertical to the optical axis.

7. The OIS camera module of claim 5, wherein the OIS camera module includes a first OIS actuator and a second OIS actuator as the OIS actuator, the first OIS actuator is disposed while forming an angle of 110 to 145 degrees with respect to the AF actuator, and the second OIS actuator is disposed while forming an angle of 210 to 250 degrees with respect to the AF actuator.

8. A dual camera system comprising:
a module base;
a lens carrier movably mounted on the module base; and
at least one OIS actuator controlling movement of the lens carrier in a horizontal direction vertical to an optical axis of the lens carrier,
wherein a first OIS camera module and a second OIS camera module are provided at an interval of equal to or less than 3 mm,
in the first OIS camera module and the second OIS camera module, each OIS actuator includes a coil and a magnet unit, and
all main magnetic flux line directions of the magnet unit included in the OIS actuator are aligned parallel to the optical axis.

9. The dual camera system of claim 8, wherein the magnet unit includes a first magnet and a second magnet in which the main magnetic flux line direction is parallel to the optical axis to correspond to one coil, and
wherein the first magnet and the second magnet are disposed adjacent to each other in the horizontal direction and pole directions of magnetic fields are opposite to each other.

10. The dual camera system of claim 8, wherein the magnet unit includes the first magnet, the second magnet, the third magnet, and a fourth magnet in which the main magnetic flux line direction is parallel to the optical axis to correspond to one coil,
wherein the first magnet and the second magnet are disposed adjacent to each other in the horizontal direction below the coil and the pole direction of the magnetic fields are opposite to each other,
wherein the third magnet and the fourth magnet are disposed adjacent to each other in the horizontal direction above the coil and the pole directions of the magnetic fields are opposite to each other,
wherein the first magnet and the third magnet are disposed to correspond to each other up and down based on the coil, and
wherein the second magnet and the fourth magnet are disposed to correspond to each other up and down based on the coil.
